(19) United States
(12) Patent Application Publication
(10) Pub. No.: US 2003/0000643 A1
(43) Pub. Date: Jan. 2, 2003

(54) Aqueous adhesive preparation

(76) Inventors: Bernhard Herlfterkamp, Bottrop (DE); Ludwig Broich, Twist (DE); Hermann Onusseit, Haan (DE); Ingo Gensch, Linnich (DE); Thomas Schreyer, Koeln (DE)

Correspondence Address: Michael E. Carmen, Esq., DILWORTH & BARRESE, LLP, 333 Earle Ovington Blvd., Uniondale, NY, 11553, US

(21) Appl. No.: 10/219,977

(22) Filed: Aug. 15, 2002

Related U.S. Application Data
(62) Division of application No. 09/530,379, filed on Jul. 12, 2000.
Application No. 09/530,379 is a 371 of international application No. PCT/EP98/06594, filed on Oct. 17, 1998.

(30) Foreign Application Priority Data
Oct. 27, 1997 (DE) 197 42 449.7

(51) Int. Cl. C09J 1/00

(52) U.S. Cl. 156/327

(57) ABSTRACT

Aqueous adhesive preparations, more particularly for labeling bottles, were to be formulated in such a way that high adhesion and the absence of odors during delabeling would be guaranteed. This was achieved by using aqueous preparations containing 1 to 70% by weight of a copolymer of monomers containing acid groups and hydrophobic monomers and, if desired, one or more auxiliaries for improving wet adhesive strength and/or for controlling open time and, if desired, preservatives, defoamers, dyes and/or other typical auxiliaries as labeling adhesives for bonding water-permeable hydrophilic substrates to hard surfaces.

This invention relates to the use of special synthetic polymers soluble or dispersed in water for bonding hydrophilic, water-permeable substrates to hard surfaces, more particularly plastic surfaces.

It has been known for some time that aqueous adhesive preparations can be used for bonding water-permeable substrates. A major field of application, for example, is the labeling of bottles. For example, it is proposed in German patent application DE 195 21 564 to form a wrap-around labeling adhesive system from a pickup adhesive and an overlap adhesive. The pickup adhesive is said to have high wet adhesive strength and to consist of 5 to 85% by weight of a water-soluble polymer based on casein, starch, dextrin, glucose, polyvinyl alcohol, polyvinyl urethane or polyacrylic acid. Although adhesives such as these can be successfully used in practice, the application of paper labels to hydrophobic substrates does present difficulties. This applies in particular to the polyacrylic acid—an extremely hydrophilic polymer—which is mentioned in the document cited above.

DE-OS 21 07 651 describes a process for the production of a mechanically stable polymer latex consisting of hydrophobic monomers and carboxyfunctional monomers. Besides the production of the latices, the document in question also describes their use for the treatment of textiles or for pigmenting in the production of pigmented paints. However, there is no suggestion that neutralization products of the latex are suitable as adhesives.

Applicants' International patent application WO 93/3111 describes water-containing adhesives for the labeling of bottles. These labeling adhesives are based on a glue, a rosin, a synthetic resin and monohydric or polyhydric alcohols. There is no reference to the use of copolymers of hydrophobic and monomeric and acid-group-containing monomers.

Although relatively hydrophobic surfaces can be bonded extremely well with casein-based glues, unpleasant odors can be emitted under adverse conditions in industrial cleaning processes used to remove the labels.

Accordingly, the problem addressed by the present invention was to develop an aqueous adhesive preparation which would develop high adhesive strength on hydrophobic surfaces, of which the viscosity would be dependent to a large extent on temperature, which would show sufficiently good adhesion and which, in addition, would not lead to any odor emission or to the penetration of odor-forming substances into the plastic layer during the machine removal of labels.

Accordingly, the present invention relates to the use of aqueous preparations containing

1 to 70% by weight of a copolymer of monomers containing acid groups and hydrophobic monomers and, if desired,

one or more auxiliaries for improving wet adhesive strength and/or for adjusting the open time and, if desired,

preservatives, defoamers, dyes and/or other typical auxiliaries as labeling adhesives for bonding water-permeable hydrophilic substrates to hard surfaces.

A general embodiment of the invention is characterized by the use of copolymers of hydrophobic units and acid-bearing units as binders, preferably as the dominant binder and, more preferably, even as the sole binder in water-containing adhesives of the type mainly used for bonding paper to hydrophobic surfaces. Without wishing to confine the invention to any particular theory, it is assumed that the hydrophobic components of such polymers enter into an adhesive bond with hydrophobic surfaces while the hydrophilic components also present bond to hydrophilic substrates.

The solubility of the polymers used in accordance with the invention is dependent on the pH value, i.e. the polymer is insoluble at pH values in the acidic range where the acid group is present to only a limited extent, if at all, as ions. It is only through neutralization that the substances become so hydrophilic that they pass into solution.

The copolymers used as adhesives in accordance with the present invention are preferably formed by copolymerization of at least one monomer of type A with at least one monomer of type B, other monomers of type C optionally being used as well. The following observations apply to these various types of monomer:

Monomers of type A are hydrophobic components, i.e. copolymerized monomers which form a discrete, disperse organic liquid phase in water as the continuous phase under the emulsion copolymerization conditions according to the invention. Suitable monomers of this type are esters of unsaturated polymerizable carboxylic acids, more particularly acrylic and methacrylic acid, aromatic vinyl compounds, such as styrene, α-methyl styrene and vinyl toluene, esters of vinyl alcohol, more particularly fatty acid vinyl ester, higher N-alkylamides of unsaturated polymerizable carboxylic acids, more particularly acrylic acid and methacrylic acid, and other copolymerizable olefinic monomers, for example of the acrylonitrile and methacrylonitrile, vinyl chloride or vinylidene chloride type, and olefins, such as ethylene, butadiene, chlorobutadiene and isoprene and comparable olefins with no other functionality. The esters of acrylic acid and methacrylic acid, more especially corresponding esters with lower monohydric alcohols, such as C₁₋₅ alcohols, above all the corresponding methyl, butyl, 2-ethylhexyl and/or ethyl esters, are of particular importance for these type A monomers.

Aromatic vinyl compounds of the styrene type are also particularly suitable. Esters of vinyl alcohol and olefins with no other functionality are less preferred. One feature common to the type A monomers, besides their hydrophobic properties, is the fact that they do not contain a group directly forming a salt.

The monomers of type B are components which contain acid groups. Carboxyfunctional comonomers are particularly important in this regard. Preferred examples are acrylic acid, methacrylic acid, itaconic acid and/or crotonic acid. Maleic acid, fumaric acid or semiesters thereof are less preferred. Other examples of components of this class are haloacrylic acids, such as α-chloroacrylic acid, or even comonomers containing acidic groups which cannot be attributed to a carboxyl group function. One example is styrene sulfonic acid.

Whereas monomers of types A and B are always used in the production of the adhesive components according to the invention, the use of the components C described in the following is optional. Suitable components C are hydrophilic copolymerizable monomers of which typical examples are acrylamide, methacrylamide, hydroxyethyl acrylate or methacrylate, hydroxyethyl acrylamide and N-vinyl pyrrolidone. Other monomers of this type are hydroxypropyl acrylate or methacrylate, hydroxy-butyl acrylate, partial esters of glycerol and acrylic acid.

In one preferred embodiment of the invention, the molar ratio of hydrophobic monomers to the monomers containing acid groups is selected so that at least 15 mole-% of hydrophobic monomers and at least 10 mole-% of monomers containing acid groups are used.

In addition, up to 60 mole-% of the hydrophobic monomers or the monomers containing acid groups can be replaced by monomers of type C.

The choice of suitable monomer mixtures will be guided by the following basic considerations:

To guarantee an adequate hydrophobic character of the copolymers, at least 15 mole-% of hydrophobic monomers should be present although 30 to 50 mole-% are preferably used. Comonomers with a very pronounced hydrophobic character, such as 2-ethylhexyl acrylate, tend to be able to be used in relatively small quantities whereas monomers of type A with relatively short hydrophobic side groups, such as methyl acrylate or methyl methacrylate, may be used in relatively large quantities. Similar considerations apply to the determination of a suitable number of monomers containing acid groups. For example, monomers containing sulfonic acid groups may be used in quantities of only 10 to 20 mole-% whereas monomers containing carboxylic acid groups, such as acrylic acid or methacrylic acid, are preferably used in quantities of 20 to 60 mole-%.

Copolymers having the following composition have proved to be particularly successful:

| | |
|---|---|
| ethylacrylate, butylacrylate and/or styrene | 40 to 90% by weight |
| acrylic acid and/or methacrylic acid | 10 to 60% by weight |
| optionally acrylamide | 0 to 50% by weight. |

For the purposes of the invention, the copolymers are preferably present in the form of aqueous solutions. To this end, the acid groups have to be at least partly neutralized, i.e. the aqueous solutions preferably have a pH value of 6.5 to 9 and, more preferably, in the range from 7 to 8.

In one particularly preferred embodiment of the invention, the adhesive solutions are prepared by a two-stage process, in which an emulsion copolymerization process is carried out in the first stage and the polymer latex obtained is converted into a solution in the second stage by at least partial neutralization of the acid groups.

The latices used in accordance with the invention are produced in known manner by emulsion copolymerization. The water, emulsifiers and monomer mixture are made into a fine-droplet emulsion (oil-in-water), after which the polymerization reaction is initiated by addition of typical catalyst components and, finally, is terminated normally after several hours at most moderately elevated temperatures (up to about 60° C.). In the preferred embodiment, low-viscosity latices are formed and, when applied in the form of a thin film, form layers with characteristic iridescent colors. However, slightly more viscous, but still pourable, latices can also be formed.

The molecular weight of the emulsion copolymers used as adhesives in accordance with the invention is normally in the range from 30,000 to 500,000 g/mole and may even reach 1 million. The viscosity values ηspec., as measured on a 0.1% solution in ethanol/acetic acid (99:1) at 25° C., are normally at least 0.1.

The solids concentration of the latices may vary within wide limits, for example between 1 and 70% by weight and, more particularly, between 10 and 50% by weight. A solids content of 25 to 40% by weight is particularly suitable. Besides the copolymers, the latices contain emulsifiers which may be present in quantities of 0.5 to 15% by weight and preferably about 1 to 10% by weight and, for the rest, water. This emulsifier content derives in particular from the production of the new adhesives in accordance with the present invention which, as already mentioned, comprises the in situ copolymerization of monomer components A, B and optionally C as disperse oil phase in the continuous aqueous phase. Any standard oil-in-water emulsifiers or emulsifier systems (nonionic, anionic or cationic surfactants) may be used. General knowledge of the stability of the latices formed may be applied in this regard. Thus, particularly preferred emulsifiers are sulfate salts or sulfosuccinate salts of polyalkoxylated alcohols, more particularly higher alcohols with a carbon chain of 8 to 20 carbon atoms, or correspondingly alkoxylated phenols.

Although, in individual cases, the latices may be used as such for bonding, it is preferred to use the aqueous neutral solutions as adhesives. Neutralization may be carried out with a non-volatile base, such as an alkali metal hydroxide, or a non-volatile amine, for example triethanolamine. Sodium hydroxide, potassium hydroxide and/or mono-, di- or triethanolamine are preferred.

In individual cases, it may even be appropriate to neutralize the latices with a volatile base, for example ammonia, or a volatile amine. This is particularly desirable in cases where the adhesive bond is intended to show improved resistance to water after storage for a while.

The production of corresponding latices and their neutralization is well-known to the expert, cf. for example DE-OSS 21 07 651, 21 35 073 and 31 30 992.

The adhesives according to the invention may contain other raw materials typically encountered in labeling adhesives or may be mixed or blended with typical labeling adhesives. For example, polysaccharides, such as native starches, degraded starches, chemically modified starches, dextrins or proteins, polyvinyl alcohol, copolymers of vinyl acetate or resins, particularly water-soluble gum or liquid rosins, and chemical reaction products thereof may be used to improve wet adhesive strength. Of these materials, starch, starch derivatives, dextrin and cellulose ethers are preferred. Suitable starch derivatives may be obtained by reacting native or degraded starch, for example oxidatively degraded starch. These starch derivatives are generally reaction products with, for example, ethylene oxide, propylene oxide, acrylonitrile, chloroacetic acid or even epoxypropane sulfonic acid. The degree of substitution should be relatively low, for example between 0.02 and 0.1 DS. The dextrin used may be the commercially available, thin-, medium- or thick-boiling dextrin which may be obtained in known manner by degradation of starch.

Suitable resins are, above all, rosins. Rosins are glass-like amorphous masses with average molecular weights below 2,000 g/mole. They are obtained from the crude resin of conifers and consist predominantly of unsaturated carboxylic acids with the empirical formula C₂₀H₃₀C₂, such as abietic acid and isomers thereof. However, other more or less neutral substances, such as fatty acid esters, terpene alcohols and hydrocarbons, may also be present. A derivatized rosin, for example a hydrogenated or disproportionated rosin, is preferably used, the objective of derivatization—for example saponification or addition of maleic acid—being above all to increase solubility in water. Suitable rosins and derivatives thereof are gum, liquid and wood rosins. Water-soluble gum rosin derivatives with a solubility of at least 3 g in 100 g water at 25° C. are particularly suitable.

“Synthetic resins” in the content of the invention are products formed by condensation or polymerization which are generally amorphous, do not have a clearly defined melting point and may vary from liquid to resin-like or solid in consistency. Hydrocarbon resins, i.e. thermoplastic polymers with a low average molecular weight of less than 2,000, are preferably used. Both petroleum resins, coal tar resins and terpene resins are suitable.

Other auxiliaries which may be used in the adhesive preparations according to the invention are auxiliaries for controlling the open time, more particularly from the class of alcohols. These auxiliaries are normally used in quantities of up to 20% by weight and preferably in quantities of 5 to 10% by weight. Sugars, mono-, di- or polyalcohols, for example, are suitable as auxiliaries for controlling the open time. The alcohols not only act as solubilizers, they are also sometimes crucial to the strength of the bond. Accordingly, they are preferably liquid and undergo virtually no evaporation from the adhesive system at 25° C. Alcohols with a solubility of more than 3 g in 100 g of water at 25° C. are preferably used. The alcohols may be aliphatic or cycloaliphatic, saturated or unsaturated hydrocarbons with a linear or branched chain. They may also contain other hetero atoms, for example oxygen in the form of an ether group. Specific examples are methanol, ethanol, propanol, butanol, benzyl alcohol, cyclohexanol, di-, tri- and polyethylene glycol. Dihydric and polyhydric alcohols, more particularly ethane-1,2-diol, propane-1,2-diol and/or propane-1,2,3-triol, are preferred.

The content of copolymers used in accordance with the invention, the content of auxiliaries for controlling open time and the content of auxiliaries for improving wet adhesive strength can be varied within wide limits. Thus, the copolymers to be used in accordance with the invention are used in quantities of 1 to 70% by weight and preferably in quantities of 5 to 50% by weight The auxiliaries for controlling open time may be used in quantities of 0 to 20% by weight and preferably 5 to 10% by weight. The auxiliaries for improving wet adhesive strength may be used in quantities of 0 to 40% by weight. In their case, however, only very small quantities (for example 5 to 20% by weight), if any, are required by virtue of the already very good wet adhesive strength of the preparation according to the invention.

In addition, the adhesives according to the invention may contain other additives to obtain special properties, for example in regard to viscosity, solubility, storage life, processing properties, color and the like. These additives are generally used in quantities of no more than 5% by weight and preferably in quantities of 0.01 to 4% by weight.

Thus, benzoates, fluorides, such as sodium fluoride, amidic substances and hydroxybenzoic acid esters, for example p-hydroxybenzoic acid methyl ester or butyl ester, in quantities of 0.2 to 0.6% by weight are advantageously used as preservatives. Suitable antifoam agents are stearates, silicone oil and addition products of ethylene oxide or propylene oxide with fatty alcohols containing 12 to 18 carbon atoms in quantities of 0.3 to 2.5% by weight. The flowability of the adhesive can be regulated in known manner by addition of certain water-soluble low-molecular weight liquefiers. These include in particular urea, thiourea and/or dicyanodiamide and also inorganic or organic salts, such as halides, nitrates, sulfates, etc. Other additives include fragrances, dyes or fillers and surfactants as wetting agents. Where the adhesives according to the invention are produced by neutralization of a polymer latex, surfactants are already present.

The adhesives to be used in accordance with the invention are prepared in known manner by mixing the components. It may be advisable initially to prepare a polymer solution by neutralizing and dissolving the copolymer and then to add an aqueous or alcoholic solution or dispersion of the other components to the resulting polymer solution.

The viscosity of the final adhesive is normally in the range from 10,000 to 200,000 mPa·s and, more particularly, in the range from about 20,000 to 100,000 mPa·s at 25° C., as measured with a Brookfield viscosimeter.

The adhesives according to the invention are particularly suitable for applying paper, more particularly paper labels, to plastic surfaces. Effective bonding presupposes adequate wetting of the plastic surface with the aqueous adhesive according to the invention. This exists in particular when the surface energy sigma amounts to >33 mJm⁻², as measured in accordance with ASTM 2578-67. Thus, bonding to PU-coated glass, polystyrene, polycarbonate, polyvinyl chloride, polyethylene terephthalate, is so strong that paper labels tear on removal. However, the adhesive according to the invention may also be used for other plastics, for example for polyethylene or polypropylene.

The articles to be labeled may consist entirely of plastic, for example plastic containers, such as bottles, canisters, buckets, beakers, etc. However, they may also have only one plastic surface and may otherwise consist of metal, glass or wood, for example tin cans, coated glass bottles, painted wood, etc.

### EXAMPLES

1. Production of the Adhesive

A commercially available polyacrylate dispersion based on butyl acrylate/acrylic acid (for example Jagotex KEM 2779, a product of Jäger, Düsseldorf) is diluted to a solids content of about 35% by weight and adjusted with sodium hydroxide to a pH value of 8 to 9. The clear viscous solution obtained may be directly used as an adhesive.

2. Labeling

Using this adhesive solution, commercially available polyurethane coated reusable bottles were labeled with Superkote SK and Terroset paper labels (products of Feldmühle) in accordance with VDI Guideline 3821 by first applying the adhesive to the label in a layer thickness of about 100 μm. The label and bottle were then brought together under light pressure. The adhesion of the copolymer solution was sufficient for the bottles to be securely labeled. Removal of the labels was not accompanied by any troublesome odor emission from the adhesive bonds.

1. The use of aqueous preparations containing
1 to 70% by weight of a copolymer of monomers containing acid groups and hydrophobic monomers and, if desired,
one or more auxiliaries for improving wet adhesive strength and/or for adjusting the open time and, if desired,
preservatives, defoamers, dyes and/or other typical auxiliaries as labeling adhesives for bonding water-permeable hydrophilic substrates to hard surfaces.

2. The use claimed in claim 1, characterized in that the preparation consists of:
5 to 50% by weight of copolymer,
0 to 20% by weight and preferably 5 to 10% by weight of auxiliaries for controlling open time,
0 to 40% by weight and preferably 5 to 20% by weight of auxiliaries for improving wet adhesive strength,
0 to 5% by weight and preferably 0.01 to 4% by weight of dyes, defoamers, solvents, preservatives and/or other additives typically encountered in labeling adhesives.

3. The use claimed in claim 1 or 2, characterized in that the copolymer consists of 15 to 90 mole-% of hydrophobic monomers and 80 to 10 mole-% of monomers containing acid groups.

4. The use claimed in claims 1 to 3, characterized in that up to 60 mole-% of the hydrophobic monomers or the monomers containing acid groups is replaced by water-soluble nonionic monomers, although the lower limit for hydrophobic monomers is at least 15 mole-% and preferably at least 30 mole-%.

5. The use claimed in any of claims 1 to 4, characterized in that the preparation is present in the form of a solution with a pH value of 6.5 to 9 and preferably 7 to 8.

6. The use claimed in any of claims 1 to 5, characterized in that the solution is prepared by a two-stage process, in which an emulsion copolymerization process is carried out in the first stage and the polymer latex obtained is converted into a solution in the second stage by at least partial neutralization of the acid groups.

7. The use claimed in any of claims 1 to 6, characterized in that the preparation is neutralized with a non-volatile base, more particularly an alkali metal hydroxide.

8. The use claimed in any of claims 1 to 6, characterized in that the preparation is neutralized with a volatile base, more particularly ammonium hydroxide, or a volatile amine.

9. The use claimed in any of claims 1 to 8, characterized in that native starches, degraded starches, chemically modified starches, dextrins, proteins, polyvinyl alcohols, copolymers of vinyl acetate or resins, more particularly water-soluble gum or liquid rosins, and chemical reactions products thereof are used to improve wet adhesive strength.

10. The use claimed in any of claims 1 to 9, characterized in that sugars, mono-, di- and/or polyalcohols are used as the auxiliaries for controlling open time.

11. The use claimed in any of claims 1 to 10, characterized in that defoamers, preservatives, dyes, fragrances and/or the like are present as further auxiliaries.

12. The use claimed in any of claims 1 to 11, characterized in that the hard surfaces used are polyurethane-coated glass, polyethylene terephthalate, PVC, polystyrene, polyethylene and/or polypropylene.

13. The method of claim 1 wherein the step of providing an aqueous adhesive comprises providing an adhesive further comprising one or more compounds for improving wet adhesive strength selected from the group consisting of native starches, degraded starches, chemically modified starches, dextrins, proteins, polyvinyl alcohols, copolymers of vinyl acetate or resins, water-soluble gum or liquid rosins, and chemical reaction products thereof.

14. The method of claim 1 wherein the step of providing an aqueous adhesive comprises providing an adhesive further comprising one or more compounds for controlling open time selected from the group consisting of sugars, mono-, di- or polyalcohols and combinations thereof.

15. The method of claim 1 wherein the step of providing an aqueous adhesive comprises providing an adhesive further comprising one or more additives selected from the group consisting of solvents, preservatives, defoamers, fragrances and dyes.

16. The method of claim 1 wherein the step of providing an aqueous adhesive comprises providing an adhesive further comprising one or more hydrophilic copolymerizable compounds selected from the group consisting of acrylamide, methacrylamide, hydroxyethyl acrylate, hydroxyethyl methacrylate, hydroxyethyl acrylamide, N-vinyl pyrrolidone, hydroxypropyl acrylate, hydroxypropyl methacrylate, hydroxybutyl acetate and partial esters of glycerol and acrylic acid.

17. The method of claim 1 wherein the step of providing an aqueous adhesive comprises providing an adhesive comprising
a.) 5 to 50% by weight of a copolymer of monomers containing acid groups and hydrophobic monomers;
b.) 5 to 10% by weight of one or more compounds for controlling open time;
c.) 5 to 20% by weight of one or more compounds for improving wet adhesive strength; and
d.) 0.01 to 4% by weight of one or more additives selected from the group consisting of dyes, defoamers, solvents, preservatives and hydrophilic copolymnerizable compounds selected from the group consisting of acrylamide, methacrylamide, hydroxyethyl acrylate, hydroxyethyl methacrylate, hydroxyethyl acrylamide, and N-vinyl pyrrolidone, hydroxypropyl acrylate, hydroxypropyl methacrylate, hydroxybutyl acetate and partial esters of glycerol and acrylic acid.

18. The method of claim 1 wherein the step of providing an aqueous adhesive comprises providing an adhesive comprising a copolymer comprising about 15 to 90 mole % of hydrophobic monomers and about 80 to 10 mole % of monomers containing acid groups.

19. The method of claim 1 wherein the step of providing an aqueous adhesive comprises providing an adhesive that includes a copolymer derived from hydrophobic monomers, monomers containing acid groups and up to 60 mole % water-soluble nonionic monomers.

20. The method of claim 1 wherein the step of providing an aqueous adhesive comprises providing an adhesive that includes a copolymer containing at least 30 mole % of units derived from hydrophobic monomers.

21. The method of claim 1 wherein the step of providing an aqueous adhesive comprises providing an adhesive in the form of a solution with a pH value of 6.5 to 9.

22. The method of claim 1 wherein the step of providing the aqueous adhesive comprises the steps of conducting an emulsion copolymerization process to obtain a polymer latex and converting the polymer latex into a solution by at least partial neutralization of the acid groups.

23. The method of claim 22 wherein the step of converting the polymer latex into a solution by at least partial neutralization of the acid groups is performed using a base selected from the group consisting of ammonium hydroxide and volatile amines.

24. An aqueous adhesive composition comprising water and 1 to 70% by weight of a copolymer of monomers containing acid groups and hydrophobic monomers.

25. The aqueous adhesive composition of claim 24 further comprising one or more compounds for improving wet adhesive strength selected from the group consisting of native starches, degraded starches, chemically modified starches, dextrins, proteins, polyvinyl alcohols, copolymers of vinyl acetate or resins, water-soluble gum or liquid rosins, and chemical reaction products thereof.

26. The aqueous adhesive composition of claim 24 further comprising one or more compounds for controlling open time selected from the group consisting of sugars, mono-, di- or polyalcohols and combinations thereof.

27. An aqueous adhesive composition comprising water and 1 to 70% by weight of a copolymer of monomers containing acid groups and hydrophobic monomers and one or more additives selected from the group consisting of solvents, preservatives, defoamers, fragrances and dyes.

28. The aqueous adhesive composition of claim 24 further comprising one or more hydrophilic copolymerizable compounds selected from the group consisting of acrylamide, methacrylamide, hydroxyethyl acrylate, hydroxyethyl methacrylate, hydroxyethyl acrylamide, N-vinyl pyrrolidone, hydroxypropyl acrylate, hydroxypropyl methacrylate, hydroxybutyl acrylate and partial esters of glycerol and acrylic acid.

29. An aqueous adhesive composition comprising
a.) 5 to 50% by weight of a copolymer of monomers containing acid groups and hydrophobic monomers;
b.) 5 to 10% by weight of one or more compounds for controlling open time;
c.) 5 to 20% by weight of one or more compounds for improving wet adhesive strength; and,
d.) 0.01 to 4% by weight of one or more additives selected from the group consisting of dyes, defoamers, solvents, preservatives and hydrophilic copolymerizable compounds selected from the group consisting of acrylamide, methacrylamide, hydroxyethyl acrylate, hydroxyethyl methacrylate, hydroxyethyl acrylamide, N-vinyl pyrrolidone, hydroxypropyl acrylate, hydroxypropyl methacrylate, hydroxybutyl acrylate, partial esters of glycerol and acrylic acid.

30. An article of manufacture comprising:
a water-permeable hydrophilic first substrate; a second substrate having a hard surface; and an aqueous adhesive composition for bonding the water-permeable hydrophilic first substrate to the hard surface of the second substrate, the adhesive composition sandwiched between the first substrate and the second substrate and comprising water and a copolymer of monomers containing acid groups and hydrophobic monomers.

31. The article of manufacture of claim 30 wherein the monomers containing acid groups of the copolymer are selected from the group consisting of acrylic acid, methacrylic acid, itaconic acid, crotonic acid, maleic acid, fumaric acid and combinations thereof.

32. The article of manufacture of claim 30 wherein the hydrophobic monomers of the copolymer are esters of unsaturated polymerizable carboxylic acids.

33. The article of manufacture of claim 30 wherein the copolymer of the adhesive composition comprises a copolymer of monomers containing acid groups, hydrophobic monomers and one or more hydrophilic copolymerizable compounds selected from the group consisting of acrylamide, methacrylamide, hydroxyethyl acrylate, hydroxyethyl methacrylate, hydroxyethyl acrylamide, N-vinyl pyrrolidone, hydroxypropyl acrylate, hydroxypropyl methacrylate, hydroxybutyl acetate and partial esters of glycerol and acrylic acid.

34. The article of manufacture of claim 30 wherein the adhesive composition further comprises one or more compounds for improving wet adhesive strength selected from the group consisting of native starches, degraded starches, chemically modified starches, dextrins, proteins, polyvinyl alcohols, copolymers of vinyl acetate or resins, water-soluble gum or liquid rosins, and chemical reaction products thereof.

35. The article of manufacture of claim 30 wherein the adhesive composition further comprises one or more compounds for controlling open time selected from the group consisting of sugars, mono-, di- or polyalcohols and combinations thereof.

36. The article of manufacture of claim 30 wherein the adhesive composition further comprising one or more additives selected from the group consisting of solvents, preservatives, defoamers, fragrances and dyes.

37. The article of manufacture of claim 30 wherein the adhesive composition comprises:
a) 5 to 50% by weight of the copolymer of monomers containing acid groups and hydrophobic monomers;
b) 5 to 10% by weight of one or more compounds for controlling open time;
c) 5 to 20% by weight of one or more compounds for improving wet adhesive strength; and,
d) 0.01 to 4% by weight of one or more additives selected from the group consisting of dyes, defoamers, solvents, and preservatives.

38. The article of manufacture of claim 30 wherein the second substrate having a hard surface is a non-coated or coated material selected from the group consisting of plastic, metal, glass or wood.

39. The article of manufacture of claim 30 wherein the water-permeable hydrophilic first substrate is paper and the second substrate having a hard surface is a non-coated or coated material selected from the group consisting of plastic, metal, glass or wood.
